(19) United States
(12) Patent Application Publication
(10) Pub. No.: US 2026/0016613 A1
(43) Pub. Date: Jan. 15, 2026

(54) HIGH TEMPERATURE AND DROUGHT COMPOSITE DISASTER MONITORING AND EARLY-WARNING METHOD AND SYSTEM

(71) Applicant: Xinjiang Institute of Ecology and Geography, Chinese Academy of Sciences, Urumqi (CN)

(72) Inventor: Hui TAO, Urumqi (CN)

(21) Appl. No.: 18/793,002

(22) Filed: Aug. 2, 2024

(30) Foreign Application Priority Data
Jul. 9, 2024 (CN) 202410914894.9

(51) Int. Cl. G01W 1/10; G01W 1/14; G06N 3/02

(52) U.S. Cl. CPC G01W 1/10; G01W 1/14; G06N 3/02; G01W 2203/00

(57) ABSTRACT

The present invention relates to a high temperature and drought composite disaster monitoring and early-warning method and system, belonging to the technical fields of disaster risk assessment and early warning. Internal correlation features and abnormality information of high temperature and drought events are input into a model, multi-time-space scale features of the high temperature and drought events can be identified accurately, high event identification accuracy and space resolution are achieved, the progress can be predicted progressively, the drought and high temperature threshold change can be monitored closely, and fine forecasting and early warning can be performed in different periods, regions and intensities, thereby ensuring that indicators are in the same time scale, avoiding the complication of the high temperature and drought process caused by frequent time and space discontinuities of the indicators in a single point or small region, and ensuring the suitability for any periods of the process.

### CROSS-REFERENCE TO RELATED APPLICATIONS

The present application claims priority to Chinese Patent Application No. 2024109148949, filed Jul. 9, 2024, the entire disclosure of which is incorporated herein by reference.

### TECHNICAL FIELD

The present invention relates to the technical fields of disaster risk assessment and early warning, and in particular to a high temperature and drought composite disaster monitoring and early-warning method and system.

### BACKGROUND

High temperature disastrous weather is one of the causes of secondary meteorological disasters such as drought and fire. At present, high temperature risk assessment is still required to measure real-time meteorological data. Measuring the meteorological data requires real-time data of a large number of meteorological stations distributed in a region to be assessed. The final disaster early warning is not accurate due to errors in information acquisition and data tidying in a supervised region.

### SUMMARY

The present invention provides a high temperature and drought composite disaster monitoring and early-warning method and system so as to solve the above technical problems.

To solve the above technical problems, the present invention provides the following technical solution:
a high temperature and drought composite disaster monitoring and early-warning method includes the following steps:
S1. data acquisition:
acquiring soil moisture information observation data and ground observation station data by multi-source remote sensing information, meteorological observation and satellite images, and cleaning and preprocessing the data;
S2. data extraction:
performing fine analysis on the acquired data, extracting features of climatic data, and identifying internal correlation features and abnormality information of high temperature and drought events;
S3. model establishment:
establishing an early-warning and assessment model through coupled multi-source remote sensing information, meteorological observation and soil moisture information observation data, where the model can accurately identify time-space data features with multiple time scales, and improve the event identification precision and space resolution;
S4: model training:
training the model by historical climatic data, verifying the effect of the model by a verification set, and adjusting a hyper-parameter to improve the accuracy and generalization ability of the model;
S5: model application:
predicting future climatic data by the trained model, combining with a standardized yield variable, a crop disaster area, a meteorological drought index and abnormality information to obtain the trend and possibility of climate change, and sending early-warning information; and
S6: early-warning start:
starting a corresponding emergency response mechanism according to the early-warning information to perform resource allocation and disaster management.
Preferably, the data preprocessing includes: removing an abnormal value and filling a missing value.

Preferably, the internal correlation features include precipitation, temperature, humidity, wind speed, vegetation growth state, soil moisture stress and meteorological precipitation surplus and deficit.

Preferably, the abnormality information includes vegetation abnormality, ground temperature abnormality and precipitation abnormality.

Preferably, the drought index is calculated according to the internal correlation features, and the calculation formula of the drought index is K=Pₘ/Fₘ.

Preferably, Pₘ is the relative variability of precipitation in this month, and Fₘ is the relative variability of evaporation in this month.

Preferably, a high temperature threshold is set according to the temperature, the high temperature threshold is greater than 35° C., a heat wave is defined as the high temperature threshold that is greater than 35° C. and appears for more than 3 days, and the heat wave is divided into a weak high-temperature heat wave, medium high-temperature heat wave and a strong high-temperature heat wave.

A high temperature and drought composite disaster monitoring and early-warning system includes:
a data acquisition module: configured to acquire and summarize data information, and transmit the data information to a data extraction module;
the data extraction module: configured to analyze and process the acquired data, and extract internal correlation features and abnormality information;
a data model: configured to establish an early-warning and assessment model;
a model training module: configured to train the data model through deep learning;
a real-time monitoring and early-warning module; configured to implement real-time monitoring and early warning of climate change and natural disasters; and
a fine forecasting and early-warning module: configured to predict a progress progressively, closely monitor drought and intensity change, and perform fine prediction and early warning in different periods, regions and intensities.

Preferably, in the fine forecasting and early-warning module, the corresponding emergency response mechanism is started according to the early-warning information to perform resource allocation and disaster management.

Preferably, the fine forecasting and early-warning module performs comprehensive summary and assessment to form an emergency response assessment report, and data information is transmitted to the data extraction module, so that the real-time monitoring and early-warning module is perfected, and the disaster accident response capability is improved.

By adoption of the above structure, the present invention has the following advantages:
according to the present invention, internal correlation features and abnormality information of high temperature and drought events are input into a model, time-space features with multiple time scales of the high temperature and drought events can be identified accurately, high event identification accuracy and space resolution are achieved, the progress can be predicted progressively, the drought and high temperature threshold change can be monitored closely, and fine forecasting and early warning can be performed in different periods, regions and intensities, thereby ensuring that indicators are in the same time scale, avoiding the complication of the high temperature and drought process caused by frequent time and space discontinuities of the indicators in a single point or small region, and ensuring the suitability for any periods of the process to dynamically assess or predict the occurrence and development trend of the high temperature and drought events.

The above overview is only for the objective of the specification and is not intended to limit in any way. In addition to the exemplary aspect, embodiments and features described above, the further aspects, embodiments and features of the present invention will be easily understood with reference to the accompanying drawings and the following detailed description.

### BRIEF DESCRIPTION OF THE DRAWINGS

To describe the technical solutions in the embodiments of the present application or in the prior art more clearly, the following briefly introduces the accompanying drawings for describing the embodiments or the prior art. Apparently, the accompanying drawings in the following description show merely some embodiments of the present application, and a person of ordinary skill in the art may still derive other drawings from the accompanying drawings without creative efforts.

FIG. 1 is a flow chart of the present invention;

FIG. 2 is a diagram of soil moisture analysis of the present invention; and

FIG. 3 is a high temperature summary diagram of Embodiment 1 of the present invention.

### DETAILED DESCRIPTION

The specific embodiments of the present invention are described in detail. Although the present invention is described in conjunction with these specific embodiments, it should be recognized that it is not intended to limit the present invention to these specific embodiments. On the contrary, these embodiments are intended to cover substituted, changed or equivalent embodiments included in the spirit and scope of the present invention as defined by the claims. In the following description, numerous specific details are set forth in order to provide a thorough understanding of the present invention. The present invention may be implemented without some or all of these specific details. In other cases, well-known process operations are not described in detail so as not to unnecessarily obscure the present invention.

When used in combination with “including”, “the method includes” or similar languages in the specification and the additional claims, the singular forms “a”, “a certain” and “the” include plural references, unless the context clearly indicates otherwise. Unless otherwise defined, all technical and scientific terms used herein have the same meaning as those generally understood by a person of ordinary skill in the art to which the present invention belongs.

The present invention is further described in detail with reference to the whole specification.

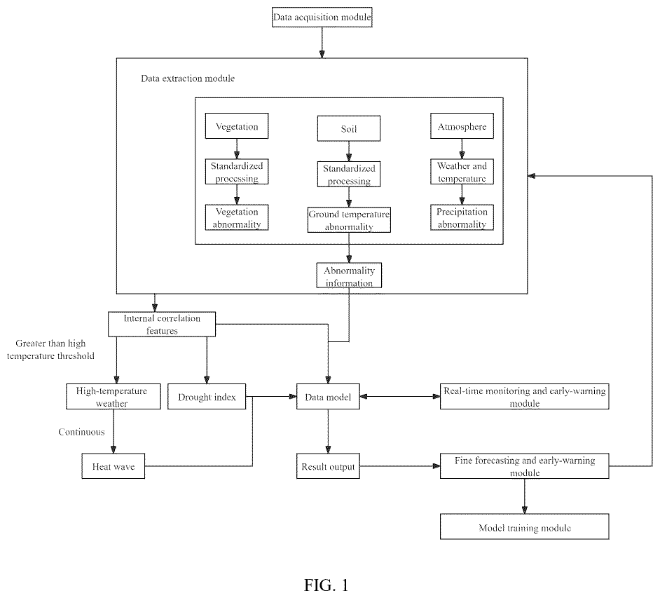

Embodiment 1: referring to FIG. 1 to FIG. 3, a high temperature and drought composite disaster monitoring and early-warning system includes:
a data acquisition module: configured to acquire and summarize data information, and transmit the data information to a data extraction module, and perform data acquisition by a multi-source remote sensing information technology, meteorological observation and soil moisture information observation data.
a data extraction module: configured to analyze and process the acquired data, and extract internal correlation features and abnormality information; and extract features, such as temperature, humidity and wind speed, in climatic data through feature engineering, and correlations therebetween.

Satellite images can be used for species recognition and classification, crop area estimation and monitoring, crop nutrient and moisture status monitoring, plant disease and insect pest monitoring and forecasting. The growth situation of crops and the distribution of agricultural resources can be understood thoroughly, thereby providing scientific basis for the monitoring and early warning of high temperature and drought disasters.

Based on an AI technology and a space-air-ground multi-source remote sensing information technology, the acquired data is subjected to fine analysis, and the internal correlation features in the composite high temperature and drought events are identified. By this method, the working efficiency and the accuracy can be improved, and human errors and interference can be reduced.

A data model is: configured to establish an early-warning and assessment model, where the early-warning and assessment model is established by coupling multi-source remote sensing information, meteorological observation and soil moisture information observation data. These models can accurately identify time-space features with multiple time scales, and improve the event identification precision and space resolution.

A model training module is: configured to train the data model through deep learning, and continuously optimize and perfect the early-warning model, so that a wider impact scenario can be covered. A deep neural network technology can be used to find a mode directly from the meteorological data and predict the precipitation probability, thereby improving the prediction efficiency and accuracy. A large number of monitoring data is processed rapidly and accurately, and the potential risk is found in time, thereby improving the accuracy and real-time property of early warning.

A real-time monitoring and early-warning module is: configured to implement real-time monitoring and early warning of climate change and natural disasters; and
a fine forecasting and early-warning module: configured to predict a progress early warning in different periods, regions and intensities.

The fine forecasting and early-warning module performs comprehensive summary and assessment to form an emergency response assessment report, and data information is transmitted to the data extraction module, so that the real-time monitoring and early-warning module is perfected, and the disaster accident response capability is improved. Specifically, the high temperature and drought events and the influence thereof are identified and assessed through high-precision real-time monitoring and early-warning module, so that the event identification precision and space resolution can be improved. Information is received and reported, and information from different channels is received and processed to ensure the timeliness and accuracy of the information. The acquired information is preliminarily determined to determine the severity and possible influence range of disasters. Consultation, research and determination are organized, the drought situation is analyzed, and countermeasures are formulated. According to the research and determination result, a corresponding emergency response level is started, and relevant departments and units are notified. Effective communication mechanism is established to ensure the unimpeded access to information among various relevant departments, including command and deployment, flood monitoring, departmental linkage, information submission, project scheduling, dike inspection, river regime monitoring, emergency response, force pre-positioning, traffic control and other contents. After the disaster is effectively controlled, emergency response is finished, and comprehensive summary and assessment are performed to form an emergency response assessment report, thereby further perfecting a contingency plan and response mechanism. Data information is transmitted to the data extraction module, so that the real-time monitoring and early-warning module is perfected, and the disaster accident response capability is improved.

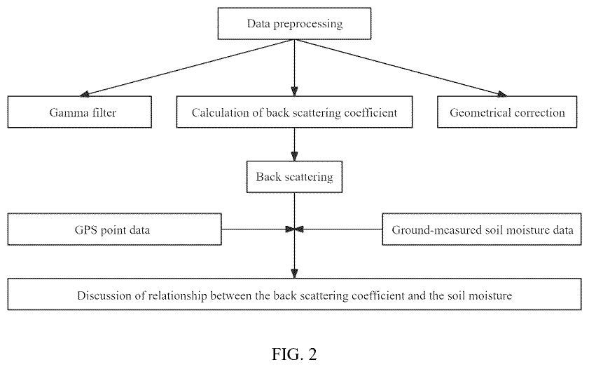

During specific implementation of the present invention, as shown in FIG. 2, a plurality of control points are selected to geometrically correct a back scattering coefficient image. The soil moisture is determined by counting a relationship between the back scattering coefficient and the soil moisture. The relationship between the back scattering coefficient and soil moisture is discussed through GPS point data and ground-measured soil moisture data.

A high temperature threshold is set according to the temperature. A weak high-temperature heat wave is the weather with the high temperature threshold greater than 35° C. for 3-5 consecutive days. A medium high-temperature heat wave is the weather with the high temperature threshold greater than 35° C. for 5-8 consecutive days. A strong high-temperature heat wave is the weather with the high temperature threshold greater than 35° C. for 8 consecutive days.

### Embodiment 2

the overview of a research area: a test area is located in Changping, Shunyi and Tongxian districts of Beijing. It is located at 115° 58′−116° 50′ east longitude and 39° 30′-4033′ north latitude, with an altitude of 30-60 m. The main types of land in the area are farmland, woodland, orchard and water body. The main types of the farmland are wheat field, alfalfa field and bare land.

The farmland is flat with little relief. Radar data used in the satellite data profile is ENVISAT-ASAR. The orbit height of the satellite is 800 kilometers, and the inspection date is from April 29 to July 14.

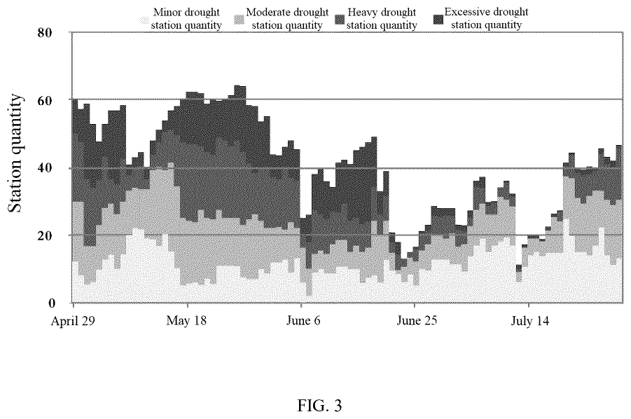

A high temperature and drought composite disaster monitoring and early-warning method includes the following steps:
S1. data acquisition:
soil moisture information observation data and ground observation station data were acquired by multi-source remote sensing information, meteorological observation and satellite images, and the data were cleaned and preprocessed;
S2. data extraction:
fine analysis was performed on the acquired data, features of climatic data were extracted, and internal correlation features and abnormality information of high temperature and drought events were identified;
S3. model establishment:
an early-warning and assessment model was established through coupled multi-source remote sensing information, meteorological observation and soil moisture information observation data, where the model can accurately identify time-space data features with multiple time scales, and improve the event identification precision and space resolution;
S4: model training:
the model was trained by historical climatic data, the effect of the model is verified by a verification set, and a hyper-parameter was adjusted to improve the accuracy and generalization ability of the model;
S5: model application:
future climatic data was predicted by the trained model, a standardized yield variable, a crop disaster area, a meteorological drought index and abnormality information were combined to obtain the trend and possibility of climate change, and early-warning information was sent; and
S6: early-warning start:
according to the early-warning information, as shown in FIG. 3, the test area was in the range of extreme drought from April 29 to June 15, from May 18 to early June, the highest index of five days was greater than 60, and extreme drought appeared, the corresponding emergency response mechanism was started to perform resource allocation and disaster management. A progress was predicted progressively, drought and intensity change were closely monitored, and fine forecasting and early warning were performed in different periods, regions and intensities.

The present invention and the embodiments thereof are described above. The description is not limited. What is shown in the whole specification is only one of the embodiments of the present invention, and the actual structure is not limited to this. In conclusion, if those of ordinary skill in the art are inspired by this, the structural modes and embodiments similar to the technical solution are designed without creativity and without departing from the creative purpose of the present invention, and should belong to the protection scope of the present invention.

What is claimed is:

1. A high temperature and drought composite disaster monitoring and early-warning method, characterized in that, comprising the following steps:
S1. data acquisition:
acquiring soil moisture information observation data and ground observation station data by multi-source remote sensing information, meteorological observation and satellite images, and cleaning and preprocessing the data;
S2. data extraction:
performing fine analysis on the acquired data, extracting features of climatic data, and identifying internal correlation features and abnormality information of high temperature and drought events;
S3. model establishment:
establishing an early-warning and assessment model through coupled multi-source remote sensing information, meteorological observation and soil moisture information observation data, wherein the model is capable of accurately identifying time-space data features with multiple time scales, and improving the event identification precision and space resolution;
S4: model training:
training the model by historical climatic data, verifying the effect of the model by a verification set, and adjusting a hyper-parameter to improve the accuracy and generalization ability of the model;
S5: model application:
predicting future climatic data by the trained model, combining with a standardized yield variable, a crop disaster area, a meteorological drought index and abnormality information to obtain the trend and possibility of climate change, and sending early-warning information; and
S6: early-warning start:
starting a corresponding emergency response mechanism according to the early-warning information to perform resource allocation and disaster management.

2. The high temperature and drought composite disaster monitoring and early-warning method according to claim 1, characterized in that, the data preprocessing comprises: removing an abnormal value and filling a missing value.

3. The high temperature and drought composite disaster monitoring and early-warning method according to claim 1, characterized in that, the internal correlation features comprise precipitation, temperature, humidity, wind speed, vegetation growth state, soil moisture stress and meteorological precipitation surplus and deficit.

4. The high temperature and drought composite disaster monitoring and early-warning method according to claim 1, characterized in that, the abnormality information comprises vegetation abnormality, ground temperature abnormality and precipitation abnormality.

5. The high temperature and drought composite disaster monitoring and early-warning method according to claim 1, characterized in that, the drought index is calculated according to the internal correlation features, and the calculation formula of the drought index is K=Pₘ/Fₘ.

6. The high temperature and drought composite disaster monitoring and early-warning method according to claim 5, characterized in that, Pₘ is the relative variability of precipitation in this month, and Fₘ is the relative variability of evaporation in this month.

7. The high temperature and drought composite disaster monitoring and early-warning method according to claim 3, characterized in that, a high temperature threshold is set according to the temperature, the high temperature threshold is greater than 35° C., a heat wave is defined as the high temperature threshold that is greater than 35° C. and appears for more than 3 days, and the heat wave is divided into a weak high-temperature heat wave, medium high-temperature heat wave and a strong high-temperature heat wave.

8. A high temperature and drought composite disaster monitoring and early-warning system, characterized in that, comprises:
a data acquisition module: configured to acquire and summarize data information, and transmit the data information to a data extraction module;
the data extraction module: configured to analyze and process the acquired data, and extract internal correlation features and abnormality information;
a data model: configured to establish an early-warning and assessment model;
a model training module: configured to train the data model through deep learning;
a real-time monitoring and early-warning module: configured to implement real-time monitoring and early warning of climate change and natural disasters; and
a fine forecasting and early-warning module: configured to predict a progress early warning in different periods, regions and intensities.

9. The high temperature and drought composite disaster monitoring and early-warning system according to claim 8, characterized in that, in the fine forecasting and early-warning module, the corresponding emergency response mechanism is started according to the early-warning information to perform resource allocation and disaster management.

10. The high temperature and drought composite disaster monitoring and early-warning system according to claim 8, characterized in that, the fine forecasting and early-warning module performs comprehensive summary and assessment to form an emergency response assessment report, and data information is transmitted to the data extraction module, so that the real-time monitoring and early-warning module is perfected, and the disaster accident response capability is improved.
